(19) United States
(12) Patent Application Publication
(10) Pub. No.: US 2012/0218927 A1
(43) Pub. Date: Aug. 30, 2012

(54) METHOD FOR NEGOTIATING POWER MANAGEMENT MODE BETWEEN MOBILE DEVICE AND ACCESS POINT, AND MOBILE DEVICE

(76) Inventor: Jing-Rong Hsieh, Taoyuan County (TW)

(21) Appl. No.: 13/404,000

(22) Filed: Feb. 24, 2012

Related U.S. Application Data
(60) Provisional application No. 61/446,505, filed on Feb. 25, 2011.

(51) Int. Cl. H04W 52/02

(52) U.S. Cl. 370/311

(57) ABSTRACT

A method for negotiating a power management mode between a first wireless device and a second wireless device is provided. One of the first and second wireless devices is a mobile device, and the other of the first and second wireless devices is an access point. The method includes: transmitting a first information from the first wireless device to notify the second wireless device whether the first wireless device supports a power management mode; and receiving a second information transmitted from the second wireless device to the first wireless device, the second information being used for indicating whether the second wireless device supports the power management mode.

### CROSS REFERENCE TO RELATED APPLICATIONS

This application claims the benefit of the filing date of U.S. provisional patent application No. 61/446,505, filed Feb. 25, 2011, the contents of which are hereby incorporated by reference.

### BACKGROUND OF THE INVENTION

1. Field of the Invention

The present invention relates to a communication negotiation scheme, and more particularly to a method for negotiating a power management mode between a mobile device and an access point, and the mobile device thereof.

2. Description of the Prior Art

When a destination of traffic (data frames) transmitted by an access point is different from a mobile device, it is better to let the mobile device enter a low power state to save energy. While the mobile device is in this low power state, the access point should buffer data traffic to be transmitted to the mobile device. For an enhanced and amended power saving mechanism to an existing communication system, an effective negotiation scheme is necessary; however, currently developed wireless local area network (WLAN) standards do not provide an effective and flexible power management negotiation scheme for an enhanced power management mode for the access point and mobile device when a transmission does not bound for the mobile device.

### SUMMARY OF THE INVENTION

It is therefore one of the objectives of the present invention to provide a method for negotiating a power management mode between a mobile device and an access point, to improve the performance of the communication system.

According to an embodiment of the present invention, a method for negotiating a power management mode between a first wireless device and a second wireless device is disclosed. One of the first and second wireless devices is a mobile device, and the other is an access point. The method comprises: transmitting first information from the first wireless device to notify the second wireless device as to whether the first wireless device supports a power management mode; and receiving second information transmitted from the second wireless device to the first wireless device, the second information being used for indicating whether the second wireless device supports the power management mode.

According to another embodiment of the present invention, a method for negotiating a power management mode between a mobile device and an access point is disclosed. The method comprises: receiving a beacon frame transmitted from the access point to the mobile device; and obtaining specific information according to the received beacon frame, wherein the specific information indicates whether the access point supports the power management mode.

According to another embodiment of the present invention, a method for indicating a power management mode status of a mobile device to an access point is disclosed. The method comprises: transmitting a first protocol data unit (PDU) from the mobile device to the access point; and receiving a second PDU transmitted from the access point to the mobile device; wherein the first PDU includes first information to notify whether the mobile device is in a power management mode or not; and the second PDU includes acknowledgement information used for confirming reception of the first information.

According to the embodiment of the present invention, a mobile device capable of negotiating with an access point for a power management mode is further disclosed. The mobile device comprises a communicating circuit and a processing circuit. The communicating circuit is utilized for transmitting first information to notify the access point whether the mobile device supports a power management mode and for receiving second information transmitted from the access point to the mobile device wherein the second information is used for indicating whether the access point supports the power management mode. The processing circuit is coupled to the communicating circuit and utilized for controlling the communicating circuit to negotiate with the access point.

According to the embodiment of the present invention, a mobile device capable of negotiating with an access point for a power management mode is disclosed. The mobile device comprises a communicating circuit and a processing circuit. The communicating circuit is used for receiving a beacon frame transmitted from the access point to the mobile device. The processing circuit is coupled to the communicating circuit and used for obtaining specific information according to beacon frame, wherein the specific information indicates whether the access point supports the power management mode.

According to the embodiment of the present invention, a mobile device capable of notifying an access point for a power management mode status is further disclosed. The mobile device comprises a communicating circuit and a processing circuit. The communicating circuit is utilized for transmitting a first protocol data unit (PDU) from the mobile device to the access point and for receiving a second PDU transmitted from the access point to the mobile device. The processing circuit is coupled to the communicating circuit and utilized for controlling the communicating circuit to negotiate with the access point. The first PDU includes information notifying whether the mobile device is in a power management mode or not, and the second PDU includes acknowledgement information used for confirming reception of the information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a wireless communication system according to an embodiment of the present invention.

FIG. 2 is a sequential diagram illustrating the mobile device as shown in FIG. 1 negotiating with the access point for the power management mode capability in accordance with a first exemplary embodiment.

FIG. 3 is a diagram illustrating the operation of sending a beacon signal to the mobile device as shown FIG. 1 in accordance with a second exemplary embodiment.

FIG. 4 is a sequential diagram illustrating an operation of the mobile device for notifying the access point as to whether it is currently in the power management mode.

### DETAILED DESCRIPTION

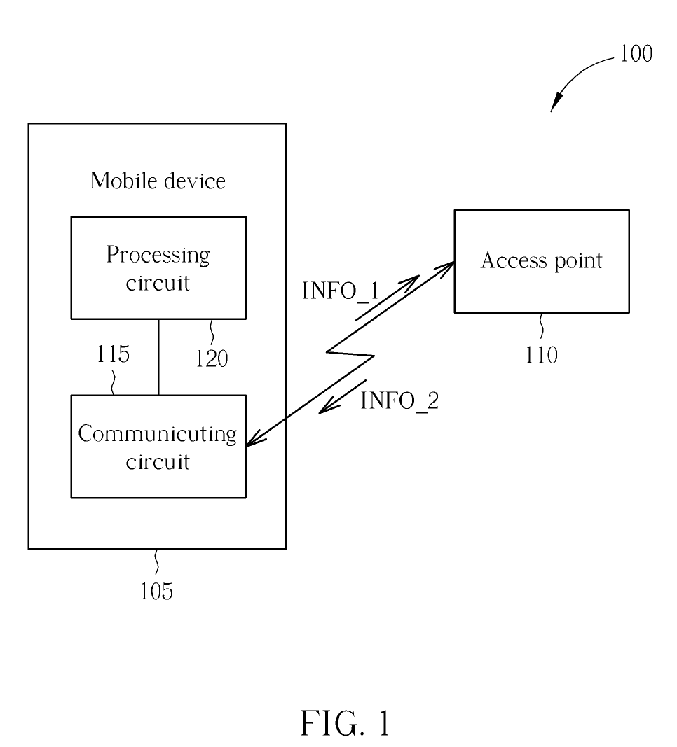

Please refer to FIG. 1, which is a block diagram of a wireless communication system 100 including at least one mobile device such as the mobile device 105 and an access point 110 according to an embodiment of the present invention. The mobile device 105 and the access point 110 in the wireless communication system 100 are respectively regarded as wireless communication devices. The wireless communication system 100 at least supports very high throughput wireless local area network (VHT WLAN) communications, and complies with a variety of WLAN standards such as IEEE 802.11 standards. The communications provided by the wireless communication system 100 are not limited to the VHT WLAN communications. In addition, the wireless communication system 100 includes a medium access control (MAC) layer which supports/provides Enhanced Distributed Channel Access (EDCA) functions for defined traffic Access Categories (ACs). An EDCA function can contend for the right to access channel for a period called a Transmission Opportunity (TXOP). The TXOP period is a bounded time interval during which a mobile device can send as many frames as possible (as long as the duration of the transmissions does not extend beyond the maximum duration of the TXOP period). When communications are ongoing between the access point 110 and one or multiple mobile devices during a TXOP period, the other mobile device(s) not participating in the transmission or reception of communications may enter ‘Doze’ state till the end of the TXOP period if the mobile device(s) is capable of supporting the TXOP power save mode (TXOP PS mode). In this embodiment, the mobile device 105 is able to support the TXOP PS mode, and negotiates with the access point 110 to enquire its capability of a power management mode (i.e. the TXOP PS mode capability). It should be noted that negotiation of the power management mode between the mobile device 105 and access point 110 refers to the negotiation of the power management mode capability or the negotiation of power management mode status/decision. The negotiation of power management mode capability refers to that the mobile device 105 negotiates with the access point 110 for the capability of power management mode. In addition, the negotiation of power management mode status/decision refers to that the mobile device 105 negotiates with the access point 110 for a result whether the mobile device 105 is in a power management mode when the power management mode is supported.

Specifically, the mobile device 105 comprises a communicating circuit 115 and a processing circuit 120. The processing circuit 120 is arranged to control the communicating circuit 115 to negotiate with the access point 110 for the power management mode capability. When the mobile device 105 negotiates with the access point 110, the communicating circuit 115 is utilized for transmitting first information INFO_1 from the mobile device 105 to the access point 110 to notify the access point 110 as to whether the mobile device 105 supports the power management mode. In addition, the access point 115 transmits second information INFO_2 to the mobile device 105, and the second information INFO_2 is used for indicating whether the access point 110 supports the power management mode. Thus, during the capability negotiation, the communicating circuit 115 is arranged to further receive the second information INFO_2 transmitted from the access point 110 to the mobile device 105.

In this way, both of the mobile device 105 and access point 110 can exchange information so as to correctly determine whether the power management mode can be supported or not. Since a conventional TXOP PS mode lacks exchange or negotiation of power saving mode capability information, using the operation of exchanging capability information between the mobile device 105 and access point 110 can correctly determine whether the power management mode can be performed or not. When the power management mode between the mobile device 105 and the access point 110 is supported, the mobile device 105 is arranged to notify the access point 110 of a decision that the mobile device 105 enters or is in the power management mode, and the access point 110 after receiving the decision is arranged to determine whether to allow state switching of the mobile device 105 in the power management mode. The mobile device 105 in the power management mode may enter either the low power state (Doze state) or a high power state (Awake state). In Awake state, the mobile device 105 is arranged to fully receive frames transmitted from the access point 110 at a higher power. In Doze state, the mobile device 105 operating at a lower power is not arranged to receive frames transmitted from the access point 110, and the access point 110 is arranged to buffer data frames to be transmitted to the mobile device 105 by using a buffer unit. It should be noted that the power states of the mobile device 105 and corresponding description are not intended to be a limitation of the present invention. The mobile device 105 may include three or more different power states.

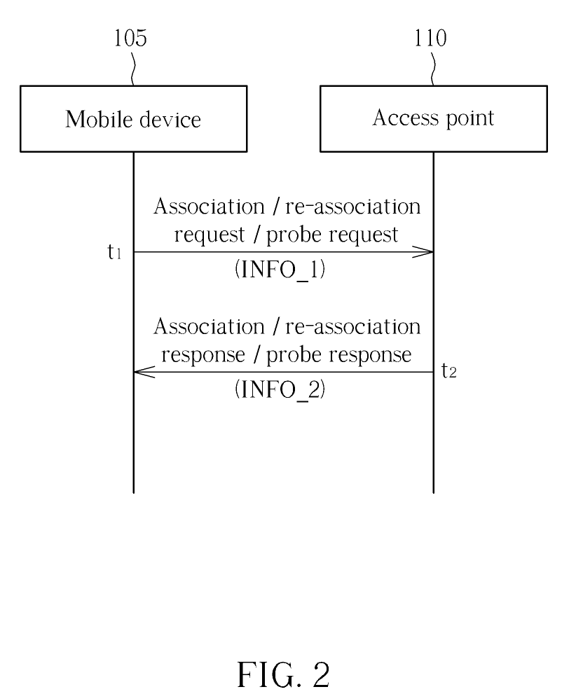

In this embodiment, the mobile device 105 is arranged to actively negotiate with the access point 110 for the power management mode capability. Please refer to FIG. 2, which is a sequential diagram of the mobile device 105 as shown in FIG. 1 negotiating with the access point 110 for the power management mode capability in accordance with a first example of this embodiment. At timing t1, the communicating circuit 115 is used for transmitting the first information INFO_1 by sending an association request including the first information INFO_1 or a re-association request including the first information INFO_1 to the access point 110 when the mobile device 105 enters/joins or scans for a basic service set (BSS) served by the access point 110. In detail, the communicating circuit 115 sends the association request to the access point 110 when the mobile device 105 joins the basic service set of the access point 110 for the first time at timing t1. In addition, the communicating circuit 115 sends the re-association request to the access point 110 when the mobile device 105 is handed over from another access point to the BSS of the access point 110 at timing t1. When receiving the first information INFO_1 sent from the mobile device 105, the access point 110 at timing t2 is arranged to transmit the second information INFO_2 by sending an association response including the second information INFO_2 or a re-association response including the second information INFO_2 to the mobile device 105 wherein the association response and the re-association response respectively correspond to the association request and the re-association request described above. Accordingly, the communicating circuit 115 can receive the second information INFO_2 by receiving the association response or the re-association response sent from the access point 110.

Alternatively, the operation of actively negotiating with the access point 110 for the power management mode can be implemented by sending a probe request and receiving a probe response. Ina second example of this embodiment, the communicating circuit 115 is used for transmitting the first information INFO_1 at timing t1 by sending a probe request including the first information INFO_1 to the access point 110. When the access point 110 receives the first information INFO_1 sent from the mobile device 105, the access point 110 is arranged to transmit the second information INFO_2 mentioned above by sending a probe response including the second information INFO_2 to the mobile device 105 wherein the probe response corresponds to the probe request. The communicating circuit 115 is arranged to receive the second information INFO_2 by receiving the probe response sent from the access point 110.

In practice, the first information INFO_1 or the second information INFO_2 can be respectively carried by the capability field named ‘VHT TXOP PS’. That is, the capability field ‘VHT TXOP PS’ in this embodiment can be used to indicate whether the mobile device 105 supports the power management mode when the capability field ‘VHT TXOP PS’ is transmitted from the mobile device 105 to the access point 110. The capability field ‘VHT TXOP PS’ can also be used to indicate whether the access point 110 supports the power management mode when the capability field ‘VHT TXOP PS’ is transmitted from the access point 110 to the mobile device 105. However, using the capability field ‘VHT TXOP PS’ to carry either the first information INFO_1 or the second information INFO_2 is not intended to be a limitation of the present invention. The first information INFO_1 or the second information INFO_2 can also be carried by another different data field or by different signaling. That is, in this embodiment, for the power management mode capability negotiation, the mobile device 105 and the access point 110 can respectively advertise whether to support the power management mode via the capability field named ‘VHT TXOP PS’. The capability field named ‘VHT TXOP PS’ is set to ‘0’ if the sender (i.e. either the mobile device 105 or the access point 110) does not support the power management mode. Otherwise, the capability field named ‘VHT TXOP PS’ is set to ‘1’ if the sender (i.e. either the mobile device 105 or the access point 110) supports the power management mode.

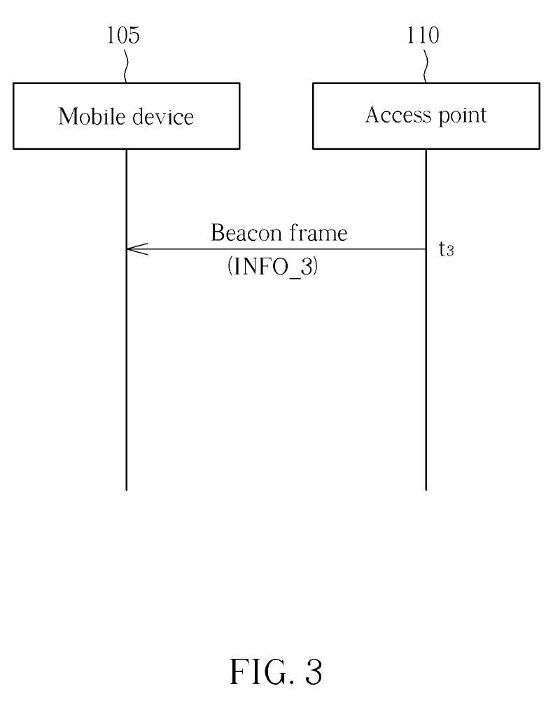

Alternatively, in another embodiment, the negotiation of the power management capability between the mobile device 105 and the access point 110 can be implemented by using the access point 110 to actively send a beacon frame to the mobile device 105. Please refer to FIG. 3, which is a diagram illustrating the operation of the mobile device 105 for receiving the beacon frame sent from the access point 105. As shown in FIG. 3, at timing t3, the access point 110 is arranged to actively send specific information INFO_3 to the mobile device 105 wherein the specific information INFO_3 is carried via the beacon frame. Accordingly, the communicating circuit 115 is arranged to receive the specific information INFO_3 by receiving the beacon frame carrying the specific information INFO_3 which is transmitted from the access point 110 to the mobile device 105. Accordingly, after the communicating circuit 115 receives the beacon frame of the access point 110, the processing circuit 210 can obtain the specific information INFO_3 according to beacon frame, wherein the specific information INFO_3 indicates whether the access point supports the power management mode. Thus, the mobile device 105 can know whether the access point 110 supports the power management mode or not. It should be noted that the beacon frame is a broadcast signal and used for helping the mobile device 105 understand if the access point 110 supports the power management mode. It is not required for the mobile device 105 to send an acknowledgement message to the access point 110 when receiving the beacon frame.

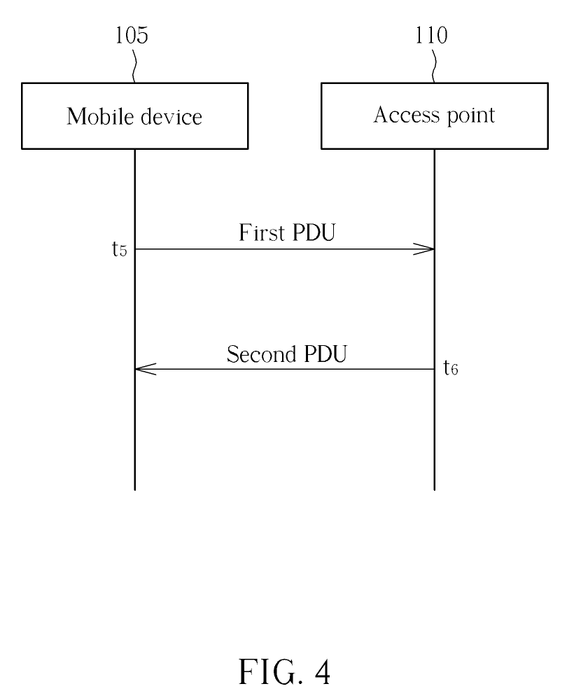

In addition, when both of the mobile device 105 and access point 110 support the power management mode, the mobile device 105 is arranged to notify the access point 110 for a power management mode decision/status. Please refer to FIG. 1 in conjunction with FIG. 4. FIG. 4 is a sequential diagram illustrating an operation of the mobile device 105 to notify the access point 110 for the power management mode status/decision made by the mobile device 105. The communicating circuit 115 as shown in FIG. 1 is arranged to transmit a first protocol data unit (PDU) from the mobile device 105 to the access point 110 at timing t5 and to receive a second PDU transmitted from the access point 110 to the mobile device 105 at timing t6. The processing circuit 120 is arranged to control the communicating circuit 115 to negotiate with the access point 110. The first PDU includes first information for indicating whether the mobile device 105 is in the power management mode or not, and the second PDU includes second information used for confirming reception of the first information included within the first PDU. In this embodiment, the first PDU and second PDU are physical level convergence procedure protocol data units (PLCP Protocol Data Unit, abbreviated as PPDU). However, this is not meant to be a limitation of the present invention.

As shown in FIG. 4, at timing t5, the communicating circuit 115 is arranged to transmit the first PDU to the access point 110 to notify the access point 110 whether the mobile device 105 is in the power management mode or not. The information carried by the first PDU can be implemented by a field carried by the first PDU such as a field included within the header of the first PDU. At timing t6, after the access point 110 receives the first PDU transmitted from the mobile device 105, the access point 110 is arranged to send the second PDU to the mobile device 105. By receiving the second PDU, the mobile device 105 can confirm that the first PDU has been received by the access point 110. For the mobile device 105, the information included within the second PDU further indicates whether the access point 110 allows the mobile devices (not only mobile device 105) to enter the low power state. That is, the information included within the second PDU is used to instruct/indicate whether the mobile devices (not only mobile device 105) can enter low power state or not when the mobile devices are in the power management mode. If the access point 110 allows mobile devices in power management mode to enter low power state and the mobile device 105 does not participate in a following TXOP, the mobile device 105 can enter the power saving state (i.e. low power state). That is, when the mobile device 105 is in the TXOP PS mode and the access point 110 allows the mobile device 105 in TXOP PS mode to enter the low power state, the mobile device 105 can enter the low power state when the access point 110 is communicating with another mobile device. Additionally, in the above-mentioned example, the first PDU can be implemented by a downlink ACK frame. In addition, the second PDU can be implemented by any kind of downlink PDU with piggybacked ACK information. As mentioned above, since the information included within the second PDU can be used for instructing the mobile device 105 whether it can enter the low power state or not in a TXOP which the mobile device does not participate in, both of the mobile device 105 and the access point 110 can know whether the mobile device 105 is allowed to be in a low power state in a TXOP which the mobile device does not participate in.

In addition, since PDUs are used for carrying data frames and are required to be exchanged frequently between the mobile device 105 and the access point 110, by sending the first PDU mentioned above, the mobile device 105 can easily and immediately notify the access point 110 whether the mobile device 105 is in the power management mode or not. The energy saving performance of the wireless communication system 100 can therefore be improved effectively. In practice, a field in the VHT preamble can be used as the information included in the first PDU for indicating that the mobile device 105 is currently in the power management mode. This field can be implemented by a single data bit included within a header of a physical layer data unit. These modifications all fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for negotiating a power management mode between a first wireless device and a second wireless device, one of the first and second wireless devices being a mobile device, and the other of the first and second wireless devices being an access point, the method comprising:
transmitting a first information from the first wireless device to notify the second wireless device whether the first wireless device supports a power management mode; and
receiving a second information transmitted from the second wireless device to the first wireless device, the second information being used for indicating whether the second wireless device supports the power management mode.

2. The method of claim 1, wherein the transmitting step comprises:
transmitting the first information when the first wireless device joins or scans for a service set served by the second wireless device.

3. The method of claim 1, wherein the transmitting step comprises:
transmitting the first information by sending an association request or a re-association request including the first information from the first wireless device to the second wireless device.

4. The method of claim 3, wherein the receiving step comprises:
receiving the second information by receiving an association response or a re-association response including the second information from the second wireless device to the first wireless device.

5. The method of claim 1, wherein the transmitting step comprises:
transmitting the first information by sending a probe request including the first information from the first wireless device to the second wireless device.

6. The method of claim 1, wherein the power management mode is a transmission opportunity power saving (TXOP PS) mode.

7. A method for negotiating a power management mode between a mobile device and an access point, comprising:
receiving a beacon frame transmitted from the access point to the mobile device; and
obtaining specific information according to beacon frame, wherein the specific information indicates whether the access point supports the power management mode.

8. A method for indicating a power management mode status of a mobile device to an access point, comprising:
transmitting a first protocol data unit (PDU) from the mobile device to the access point; and
receiving a second PDU transmitted from the access point to the mobile device;
wherein the first PDU includes a first information to notify the access point whether the mobile device is in a power management mode or not; and the second PDU includes a second information used for confirming reception of the first information.

9. The method of claim 8, wherein the second information is further used for allowing the mobile device to enter a low power state when the mobile device is in the power management mode.

10. The method of claim 8, wherein the power management mode is in a transmission opportunity power saving (TXOP PS) mode.

11. A mobile device capable of negotiating with an access point for a power management mode, comprising:
a communicating circuit, for transmitting a first information to notify the access point whether the mobile device supports a power management mode, and receiving a second information transmitted from the access point to the mobile device, the second information being used for indicating whether the access point supports the power management mode; and
a processing circuit, coupled to the communicating circuit, for controlling the communicating circuit to negotiate with the access point.

12. The mobile device of claim 11, wherein the communicating circuit is utilized for transmitting the first information when the mobile device joins or scans for a service set served by the access point.

13. The mobile device of claim 11, wherein the communicating circuit is utilized for transmitting the first information by sending an association request or a re-association request including the first information from the mobile device to the access point.

14. The mobile device of claim 13, wherein the communicating circuit is utilized for receiving the second information by receiving an association response or a re-association response including the second information from the access point to the mobile device.

15. The mobile device of claim 11, wherein the communicating circuit is utilized for transmitting the first information by sending a probe request including the first information from the mobile device to the access point.

16. The mobile device of claim 11, wherein the power management mode is in a transmission opportunity power saving (TXOP PS) mode.

17. A mobile device capable of negotiating with an access point for a power management mode, comprising:
a communicating circuit, for receiving a beacon frame transmitted from the access point to the mobile device; and
a processing circuit, coupled to the communicating circuit, for obtaining specific information according to beacon frame, wherein the specific information indicates whether the access point supports the power management mode.

18. A mobile device capable of notifying an access point for a power management mode status, comprising:
a communicating circuit, for transmitting a first protocol data unit (PDU) from the mobile device to the access point, and receiving a second PDU transmitted from the access point to the mobile device; and
a processing circuit, coupled to the communicating circuit, for controlling the communicating circuit to negotiate with the access point;
wherein the first PDU includes an information to notify the access point that whether the mobile device is in a power management mode or not; and the second PDU includes an information used for confirming reception of the information.

19. The mobile device of claim 18, wherein the information included within the second PDU is further used for allowing the mobile device to enter a low power state when the mobile device is in the power management mode.

20. The mobile device of claim 18, wherein the power management mode is in a transmission opportunity power saving (TXOP PS) mode.
